(19) United States
(12) Patent Application Publication
(10) Pub. No.: US 2015/0128443 A1
(43) Pub. Date: May 14, 2015

(54) On-Site Drying And Curing Of Paint Systems Using Catalytic Infrared Radiators

(71) Applicant: Maersk Olie og Gas A/S, Copenhagen K (DK)

(72) Inventor: Jonathan David Madden, Esbjerg V (DK)

(73) Assignee: MAERSK OLIE OG GAS A/S, Copenhagen K (DK)

(21) Appl. No.: 14/403,104

(22) PCT Filed: May 21, 2013
(86) PCT No.: PCT/DK2013/050151

§ 371 Date: Nov. 21, 2014

Related U.S. Application Data
(60) Provisional application No. 61/649,642, filed on May 21, 2012.

(30) Foreign Application Priority Data
May 21, 2012 (DK) PA201270268

(51) Int. Cl. B05D 3/02; F26B 23/06; B05D 5/00

(52) U.S. Cl. CPC B05D 3/0263; B05D 5/005; F26B 23/06
USPC 34/266; 427/542; 428/414

(57) ABSTRACT

A method is disclosed for the on-site surface coating of a structure, the structure being part of a construction including a plurality of structures, the method including the steps of: a) applying one or more layers of a coating system on-site to at least a part of the structure, b) arranging at least one gas catalytic infrared emitting unit in a position so that the infrared radiation is adapted for heating the one or more layers of the protective coating system on-site and c) irradiating the coated surface with infrared radiation emitted by the at least one gas catalytic infrared emitting unit on-site. The method allows the drying and/or curing of the one or more layers of the coating system to be accelerated.

### FIELD OF THE INVENTION

The invention relates to a method for the on-site surface coating of a structure being part of a large construction.

### BACKGROUND OF THE INVENTION

It is common to apply organic coatings to surfaces of large constructions. Often some smaller structures comprised in the construction need surface finishing with paint, for example the window frames in a building or metal structures comprised in a ship may need anti-corrosion coatings for both protective and aesthetical reasons. These applications or paint jobs can be troublesome, inconvenient and lengthy, because of for example changing weather conditions, the time during which the particular structure cannot be used and, if more than one layer of paint has to be applied, the drying time for each layer, before the next layer can be applied.

WO 2011/100970 A2 discloses a heating system suitable for heating the interior of separation tanks.

A need exists to more conveniently solve such tasks minimizing the drawbacks of organic coating applications.

### SUMMARY OF THE INVENTION

The invention relates to a method for the on-site surface coating of a structure, said structure being part of a construction comprising a plurality of structures, the method comprising the steps of:
a) applying one or more layers of a coating system on-site to at least a part of the structure;
b) arranging at least one gas catalytic infrared emitting unit in a position so that the infrared radiation is adapted for heating the one or more layers of the coating system on-site; and
c) accelerating the drying and/or curing of the one or more layers of the coating system by irradiating the coated surface with infrared radiation emitted by the at least one gas catalytic infrared emitting unit on-site.

In this context, a plurality of structures refers to sub-structures or units that when assembled make up the construction. For example, a ladder could in this context be a structure and a ship could in this context be the construction.

A problem related to the surface coating of a surface on-site is that the drying and/or curing of the coating have to take place at ambient conditions. Depending on the actual weather conditions on-site, the cure of each individual layer of a protective coating system may take long time, in some cases at least a day for each layer.

According to the invention this time can be drastically reduced by using the method of the present invention. By using gas catalytic infrared emitting units, preferably portable gas catalytic infrared emitting units, to irradiate the coating layers before the application of each new layer, the time for drying and/or curing of each layer is reduced to minutes.

A typical coating system for use as for example a repair coating for metal surfaces will provide adequate protection after curing at various ambient conditions. It has surprisingly been found that the properties of the coating system are significantly improved when using gas catalytic infrared emitting units to cure the coating system.

By using the method according to the present invention, the adhesion of the coating system to the substrate may be enhanced and the total coating thickness may be reduced. Even the number of layers to provide the necessary coating system properties may be reduced when compared to the same coating system cured under ambient conditions.

Thus, the method of the present invention can save time, making the inventive surface coating process much more efficient than prior art processes. Also coating material may be saved when compared to prior art methods also implying a reduction in costs and less environmental impact. At the same time improved adhesion compared to the prior art may be achieved, also when using standard coating systems, whereby a significant quality gain is provided by the inventive method. Because of the improved quality, intervals between re-coatings may actually be prolonged, further reducing the overall costs of maintaining a particular surface.

In an embodiment of the invention the method further comprises the step of arranging a portable enclosure on-site around at least a part of the structure.

It may be advantageous to establish an enclosure around the surface to be coated. This enclosure can protect the surface against weather conditions such as wind and rain. Also, the infrared emitting gas catalytic radiators can be arranged inside the enclosure, also protecting these from rain, snow and the like. Furthermore, the enclosure may protect the people applying the protective coating system from the weather conditions on-site.

In an embodiment of the invention said method further comprises the step of removing water from the at least a part of the structure prior to the application of one or more layers of a protective coating system by irradiating at least a part of the structure with infrared radiation emitted by the at least one gas catalytic infrared emitting unit.

Sometimes the weather conditions on-site at the site of protective coating system application are not ideal for paint applications. For example, water from the air may condense on a metal surface which is going to be protected by the protective coating system. In this case it may be very advantageous to use the infrared radiation from the gas catalytic infrared emitting unit or units to very efficiently remove the water from the metal surface, before the coating system is applied. Water will absorb the infrared radiation, typically having wavelengths between 1 and 10 μm and simply evaporate from the surface. In this way, a comparatively dry surface more suitable for applying the protective coating system is obtained.

In an embodiment of the invention said surface coating is part of a maintenance procedure.

Larger constructions cannot easily be moved and often must be maintained on-site. By use of the inventive method, the quality and speed of the maintenance procedure may be greatly enhanced.

In an embodiment of the invention said coating system is a protective coating system. In some embodiments, said coating system is applied as a repair coating.

In connection with repairs, the structure, where a part has been changed or welding has been taking place, must be surface finished to protect the newly installed part or parts from for example corrosion. On offshore constructions the closeness of seawater creates a demanding environment for metals and other construction materials such as concrete. Therefore a protective coating system may advantageously be applied to the part of the structure that has been repaired.

In an embodiment of the invention said construction is selected from the group consisting of an offshore installation, a petrochemical installation, a wind turbine, an oil rig and a ship.

According to preferred embodiments of the present invention, the method can be used on-site on larger constructions that cannot easily be moved to a convenient site for coating application, but a protective coating system is preferably applied on site to a particular structure. Previously, such coating operations were troublesome in that application of a standard protective coating system comprising for example 4 layers: An epoxy primer, 2 layers of epoxy mastic hi-build and a polyurethane topcoat would require approximately three days at a temperature on-site of about 10° C. At a lower on-site temperature, for example at 5° C., the time required for applying the above coating system may double, because the time required to cure each layer before it can be painted over with the next layer becomes quite long. It is clear that during this time, the structure being coated cannot be fully used. The costs involved in establishing adequate protection and safety around the structure or part of a structure which is coated may be high. By using the method disclosed herein, the time required to finish the application of the same protective coating system may be reduced to for example one hour, independent of the ambient temperature. Furthermore, in some cases, because of the better cure induced through the use of the inventive method, fewer coating layers may be required to achieve the same or better protection, whereby the time required may be further reduced and material costs decrease considerably.

It is clear that by going from several days to hours in order to finish the whole operation of applying and fully curing a protective coating system on-site, overall costs are significantly reduced. By applying the inventive method on large constructions like oil rigs or ships, the overall savings may be substantial and amount to millions of dollars.

In an embodiment of the invention said protective coating system has anti-corrosion properties.

In advantageous embodiments of the present invention, the protection against corrosion of structures comprised in a construction may be very efficiently performed using the method described herein. This is particularly important when the site of the construction is in corrosive environments such as a site off shore or near seawater, or when corrosive chemicals are used at the site, for example at an oil refinery.

In an embodiment of the invention said protective coating system comprises at least two layers.

Especially the dwell time between the applications of individual layers of the protective coating system may be significantly reduced when using the method of the present invention.

In this respect, the inventive method is particularly advantageous when several coating layers are required. Also layers of substantial thickness may be quickly dried and cured by using the method described herein.

In an embodiment of the invention said protective coating system comprises epoxides.

Most standard protective coating systems for demanding applications comprise binders based on epoxides. It has been found that the inventive method is very suitable for curing such coatings. The formation of cross-links in such coatings is normally around 70% of the theoretical yield, when cured under ambient conditions. By using the method of the present invention, the crosslinks formed may be as high as 80% or 90% such as 95% of those theoretically possible. This means that a protective coating system comprising epoxides, when applied according to embodiments of the present invention, becomes more dense and impermeable for moisture and other corrosives, whereby a quite surprising gain in overall performance and quality of the protective coating system is achieved.

In an embodiment of the invention said protective coating system comprises polyurethane.

As already mentioned for epoxides, a general improvement in crosslink density may be achieved for cross-linked polyurethanes as well when the application follows the method disclosed herein.

In an embodiment of the invention the portable gas catalytic infrared emitting unit is fueled by gaseous hydrocarbons.

Gaseous hydrocarbons are useful as fuel for the portable gas catalytic infrared emitting unit. A preferred fuel is natural gas providing infrared radiation having wavelengths between 1 and 10 μm that are particularly useful according to embodiments of the present invention.

In an embodiment of the invention the portable gas catalytic infrared emitting unit emits radiation having wavelengths from 1 to 10 μm.

To be particularly efficient in embodiments of the present invention, the portable gas catalytic infrared emitting units may emit wavelengths from 1-10 μm. Wavelengths within this range may effectively interact with the molecules within the protective coating system, whereby fast and efficient drying and curing of the protective coating system is obtained.

Surprisingly, the properties of the cured coating film are improved with respect to both adhesion and cross-link density when compared to the same coating film cured under ambient conditions.

This may be obtained through the action of absorbed radiation of certain wavelengths without the need of any general raise of the temperature in the surroundings.

In an embodiment of the invention the portable gas catalytic infrared emitting unit emits radiation having wavelengths from 6 to 8 μm.

Without being bound by any theory, experimental indications suggest that the very fast curing times obtainable according to advantageous embodiments of the present invention are promoted by wavelengths in the range of 6 to 8 μm. Further advantages by using these particular wavelengths in the on-site accelerated cure may be improved adhesion of the protective coating system to the substrate and a larger cross-link density within the coating when compared to the cure of the protective coating system at ambient conditions, for example at 5, 10 or 20° C.

In an embodiment of the invention the portable gas catalytic infrared emitting unit comprises at least one connector assembly.

In preferred embodiments, the portable gas catalytic infrared emitting unit has at least one connector assembly so that it can easily be attached to for example a scaffold, to a part of the structure to be coated or to another structure in the proximity of the surface to be coated.

Preferably the connector assembly is releasable to facilitate easy attachment and detachment.

Also, the connector assemblies preferably are adjustable to allow for positioning the infrared emitting units so that the coated surface is effectively irradiated by the emitted infrared radiation, when the infrared emitting unit is turned on.

The connector assembly could for example comprise clamps, bolts, screws, magnets or any other suitable means of temporary fixation.

In an embodiment of the invention emissions of volatile organic compounds from the protective coating system are removed by catalytically oxidizing the volatile organic compounds (VOC's) by the catalytic action of the portable gas catalytic infrared emitting unit.

A further advantage using the method of the present invention is the safe removal of VOC's which may evaporate from the protective coating system during drying and curing. By the air-flow into the catalytic bed of the infrared emitting unit the VOC's are also moving towards and into the catalytic bed and oxidized more or less completely to carbon dioxide.

This improves the environment around the site of coating.

In an embodiment of the invention the accelerated curing of the protective coating system is at least 10 times faster when compared to using conventional air curing at ambient conditions.

In an embodiment of the invention the accelerated curing of the protective coating system is between 20 and 200 times faster when compared to using conventional air curing at ambient conditions.

In advantageous embodiments the full cure of the protective coating system may be achieved in fractions of the time required by the curing taking place at ambient conditions. This may be true for many different protective coating systems that require large amounts of volatiles to evaporate from the coating and/or chemical reactions to take place within the coating.

In an embodiment of the invention the irradiation of the protective coating system after application on at least a part of the structure with infrared radiation emitted by the at least one gas catalytic infrared emitting units on-site, improves the adhesion of the protective coating system to the at least part of a structure by at least 10% when compared to using conventional air drying and/or curing at ambient conditions.

In an embodiment of the invention the irradiation of the protective coating system after application on at least a part of the structure with infrared radiation emitted by the at least one gas catalytic infrared emitting units on-site, improves the adhesion of the protective coating system to the at least part of a structure by 3 to 30 M Pa when compared to using conventional air drying and/or curing at ambient conditions.

Adhesion is a very important property of a coating system. In advantageous embodiments and by using standard coating material, the method provides a way to enhance the adhesion of the coating system to the substrate. This means that durability of the coating may be prolonged resulting in a reduction of maintenance costs.

Testing the adhesion may be done in several ways. In this context, we refer to ISO 4624:2002; however, testing may be done in accordance with a revised or superseding version of ISO 4264, if later issued.

In an embodiment of the invention the structure is made from a material selected from the group consisting of metal, composite, concrete, plastic or wood.

In principle the method of the present invention may be used on any surface and with many different protective coating systems. Even a combination of materials may be suitable substrates for a protective coating system applied according to embodiments of the present invention.

In an embodiment of the invention the structure is made from steel.

In preferred embodiments, the method of the present invention is used with steel as the substrate on which the protective coating system is applied. The steel can be any type of steel, in particular carbon steel or stainless steel.

The invention also relates to a construction having at least one structure treated according to the aforementioned methods.

The invention further relates to a portable drier for accelerating the drying and/or curing of the one or more layers of the protective coating. The drier is preferably used in a system according to the aforementioned methods. The drier comprises:
at least one gas catalytic infrared emitting unit generating infrared radiation by catalytic combustion of gaseous hydrocarbon fuel and
a portable enclosure for enclosing at least part of a structure and at least one catalytic radiator.

A portable catalytic drier using gaseous hydrocarbon fuel to catalytically generate infrared radiation is particularly useful for the on-site curing of a protective paint system.

The dimensions of the gas catalytic infrared emitting unit are preferably kept comparatively small to ensure easy portability. Typically, the IR-emitting surface of the IR-emitting unit measures between 5 and 30 cm in length and width, while the height would typically be between 4 and 15 cm. Each IR-emitting unit is preferably adapted for easy mounting on a scaffold or other suitable places near the site of use. For example, a steel rod extending vertically from the back of the IR-emitting unit may be used to attach the unit to a scaffold via a clamp arrangement.

The site of applying the protective coating system and curing it by the aid of infrared radiation from at least one portable gas catalytic infrared emitting unit is in certain embodiments of the invention enclosed inside a portable enclosure.

The portable enclosure ensures the protection of the coated surface from for example rain or snow while the coating and curing is taking place.

In an embodiment of the invention the portable enclosure comprises a scaffold and a tarpaulin.

The portable enclosure is in preferred embodiments of the invention built from a scaffold and a tarpaulin. This type of enclosure is versatile, can be built in suitable sizes and provides adequate protection of the site of coating and curing. Furthermore, when packed for transportation, such an enclosure may be small in size and thus well portable.

In an embodiment of the invention said portable enclosure is adapted for ventilation by air, whereby a positive pressure inside the housing can be established.

When working on-site in environments, where there is a risk of accumulating gasses that may burn or explode when in contact with hot surfaces or infrared radiation, it may be important to ventilate the site where the inventive method is applied. This may typically be done by supplying fresh air to the enclosure comprising the gas catalytic infrared radiators in an amount large enough to uphold a positive pressure inside the enclosure.

This may be important for example in connection with applications of the inventive method on an oil production platform, where it also may be necessary to install gas detectors to ensure that both the input of air into the enclosure and the output of air from the enclosure does not contain gas above a threshold limit.

In an embodiment of the invention 1 to 4 of said gas catalytic infrared emitting units can be fitted into a trunk measuring 60×40×25 cm.

In an embodiment of the invention the gas catalytic infrared emitting units can conveniently be transported to the on-site place of application in standard trunks. In this way, a good portability may be facilitated and good protection of the units during transportation may be achieved. The size of the gas catalytic infrared emitting units may thus in preferred embodiments be comparatively small so that 2 or 3 units can be fitted into a standard trunk.

### BRIEF DESCRIPTION OF THE DRAWINGS

Embodiments of the present invention are now further explained with reference to drawings and examples.

FIG. 1: Outline of a gas catalytic infrared emitting unit.

FIG. 2: Outline of a portable dryer set up for an on-site drying and curing application.

### DETAILED DESCRIPTION OF THE INVENTION

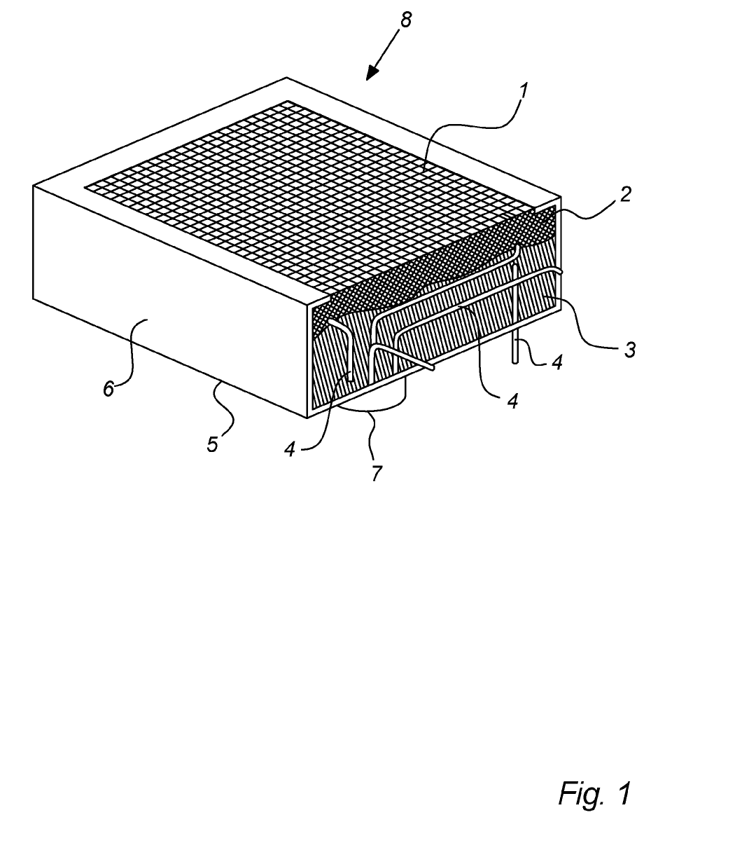

FIG. 1 shows an example of a portable gas catalytic infrared emitting unit (8). Infrared radiation is emitted from the front surface (1). A catalyst pad (2) is positioned behind the front surface. A layer of heat insulating material (3) is positioned beneath the catalyst pad (2). Tubing (4) is arranged for supplying and distributing a gaseous hydrocarbon within the catalyst pad.

The unit further comprises a back surface (5) and an enclosure (6). A rod (7) is fitted to the back surface (5) for easy mounting of the unit to a scaffold or the like.

A typical unit according to preferred embodiments of the invention may have the following dimensions: The height of the enclosure (6): 7 cm, the width of the front surface: 12 cm and the length of the front surface: 24 cm.

These dimensions are not critical and may be adapted to a certain application. Nevertheless, the units should be kept a size which facilitates portability.

The units may also comprise means for electrical pre-heating of the catalyst pad.

Gas is then supplied to the preheated catalyst pad and the hydrocarbons are catalytically oxidized maintaining the catalyst at working temperature and emitting infrared radiation from the front surface.

Gas catalytic heaters and modules are commercially available from a number of sources.

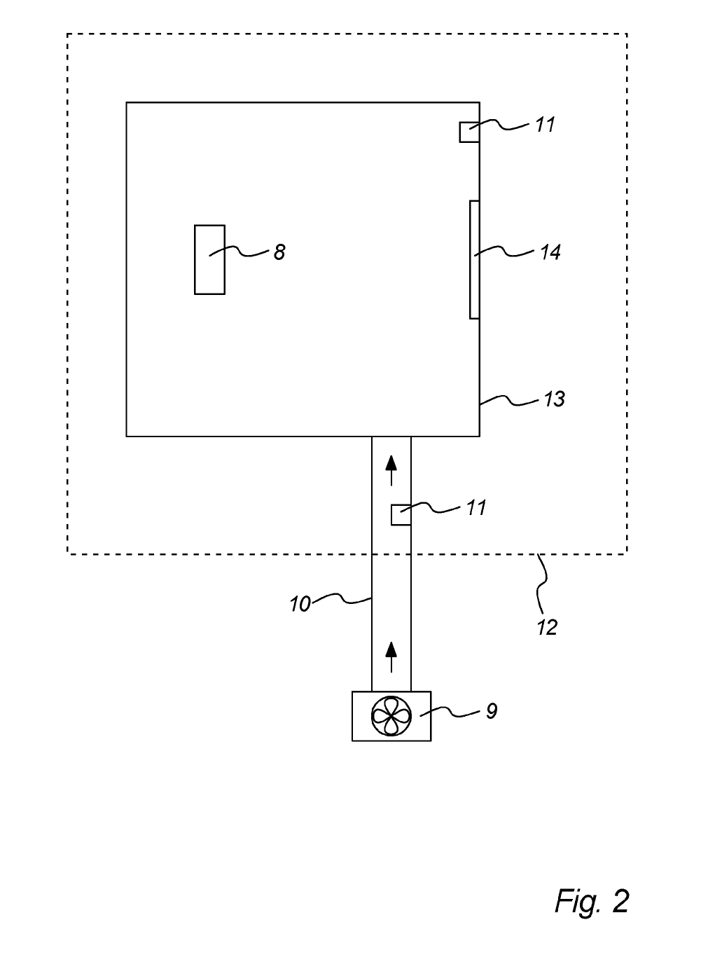

FIG. 2 shows an example of a portable drier used on-site according to an embodiment of the present method.

A gas catalytic infrared emitting unit (8) is attached inside a portable enclosure (13), for example a tent or a scaffold equipped with a tarpaulin.

A fan (9) provides an air flow into the enclosure through a hose (10) establishing a positive pressure inside the enclosure. The enclosure is situated inside a classified area indicated by the dotted line (12) while the air for ventilation is provided from a non-classified area. The classification may for example relate to a risk of leaks of substantial amounts of natural gas on an oil rig. There therefore could be a risk of explosion. A gas detector (11) is mounted both in the air supply hose and in the enclosure. An entrance (14) to access or leave the enclosure allows personnel to access the site of application of the protective paint system. Setting up the portable IR-units, given that a portable enclosure like the one outlined on FIG. 2 has been established on for example an oil rig, can be done for example within one hour.

The method of applying the protective coating system is not critical. Application may be with a brush, by spraying or any other known method.

The time required to perform the full coating operation depends on the particular coating system and the number of layers required.

Previously, when using ambient conditions to cure a coating system approved for use for demanding applications such as on an oil rig, restricted access to the area around the coated structure had to be established for several days, depending on the exact weather conditions such as the temperature. In cold environments (around 5° C. ambient temperature), proper cure of a layer could take for example 2 days before the next layer can be applied. Thus, for a 4-layer coating system, 8 days could be required before the area affected by the coating operation could be fully accessed again.

By using an installation as illustrated on FIG. 2, the same 4-layer coating system can be applied and fully cured within hours, such as for example 1 or 2 hours, or even faster.

The IR-units heat each coating layer to a temperature of for example 80° C. and keep the layer at that temperature for about 5 minutes. The surface is then allowed to cool to a temperature of about 50° C., before the next layer is applied, heated and so on. When the last layer has been kept at about 80° C. for about 5 minutes, the whole operation is ended, the portable drier can be packed and a new coating operation can be initiated at some other site.

The savings involved by using the arrangement on FIG. 2 on for example an oil rig or a ship may be substantial.

Clearly the fan, hose and gas detectors indicated on FIG. 2 may not be necessary if there is no risk for large amounts of for example inflammable substances to reach the IR-units.

### EXAMPLES

The following example illustrates some of the benefits which may be achieved according to an embodiment of the present invention.

The data given in Table 1 reflect an example for an offshore application where part of a structure of steel has to be protected against corrosion on an oil rig. The procedure when using IR reflects a setup as described on FIG. 2.

TABLE 1
Comparison of the procedure for a standard offshore on-site coating
application with an application using the method comprising the step of
curing the paint system by using portable gas catalytic infrared
emitting units.

| | Standard offshore | |
|---|---|---|
| | procedure at 10° C. on | |
| Type of coating | steel | Procedure when using IR |
| Epoxy primer | Applied thickness 50 μm | Not necessary |
| | Drying/curing minimum | — |
| | 13 hours | |
| Epoxy mastic hi- | Applied thickness 100 | Applied thickness 125 μm |
| build | μm | |
| | Drying/curing minimum | Drying/curing with IR- |
| | 23 hours | radiation approximately 30 |
| | | minutes |
| Second layer | Applied thickness 100 | Not necessary |
| Epoxy mastic | μm | |
| hi-build | Drying/curing minimum | — |
| | 23 hours | |
| Polyurethane top | Applied thickness 50 μm | Applied thickness 125 μm |
| coat | | |
| | Drying/curing minimum | Drying/curing with IR- |
| | 10 hours | radiation approximately 30 |
| | | minutes |
| Total dry film | 300 μm | 250 μm |
| thickness | | |
| Adhesion testing, | Approximately 8 MPa | Approximately 15 MPa |
| ISO 4624: 2002 | | |
| Total time | Minimum 69 hours | 60 minutes. |
| consumed for | | |
| drying/curing | | |

While the standard offshore procedure requires curing at ambient conditions, here 10° C., the procedure when using IR requires the paint film to absorb infrared radiation until a temperature of about 80° C. is reached and kept for about 5 minutes, where after the painted surface is allowed to cool to 50° C. The time required for the cooling step is taken account of in Table 1 in that approximately 30 minutes are required, before the next layer of coating can be applied.

Both procedures in Table 1 result in a coated steel surface giving a specified corrosion resistance. Evidently the performance of the IR-cured coating is better with respect to adhesion and only a two-layer system is necessary to achieve the desired corrosion resistance.

Also it is evident that the time required before the steel structure is protected and accessible for use is far less for the method using gas catalytic infrared emitting units for accelerated IR-cure.

1. A method for the on-site surface coating of a structure, said structure being part of a construction comprising a plurality of structures, the method comprising the steps of:
a) applying one or more layers of a coating system on-site to at least a part of the structure;
b) arranging at least one gas catalytic infrared emitting unit in a position so that the infrared radiation is adapted for heating the one or more layers of the coating system on-site; and
c) irradiating the coated surface with infrared radiation emitted by the at least one gas catalytic infrared emitting unit on-site.

2. The method according to claim 1, wherein said method further comprises the step of arranging an enclosure on-site around at least a part of the structure.

3. The method according to claim 1, wherein said method further comprises the step of removing water from at least a part of the structure prior to the application of one or more layers of a coating system by irradiating at least a part of the structure with infrared radiation emitted by at least one gas catalytic infrared emitting unit.

4. The method according to claim 1, wherein said surface coating is part of a maintenance procedure.

5. The method according to claim 1, wherein said coating system is applied as a repair coating.

6. The method according to claim 1, wherein said construction is selected from the group consisting of an offshore installation, a petrochemical installation, a wind turbine, an oil rig and a ship.

7. The method according to claim 1, wherein said coating system has anti-corrosion properties.

8. The method according to claim 1, wherein said coating system comprises at least two layers.

9. The method according to claim 1, wherein said coating system comprises epoxides.

10. The method according to claim 1, wherein said coating system comprises polyurethane.

11. The method according to claim 1, wherein the gas catalytic infrared emitting unit is fueled by gaseous hydrocarbons.

12. The method according to claim 1, wherein the gas catalytic infrared emitting unit emits radiation having wavelengths from 1 to 10 μm.

13. The method according to claim 12, wherein the gas catalytic infrared emitting unit emits radiation having wavelengths from 6 to 8 μm.

14. The method according to claim 1, wherein the gas catalytic infrared emitting unit comprises at least one connector assembly.

15. The method according to claim 1, wherein emissions of volatile organic compounds from the coating system are removed by catalytically oxidizing the volatile organic compounds by the catalytic action of the gas catalytic infrared emitting unit.

16. The method according to claim 27, wherein the accelerated drying and/or curing of the coating system is at least 10 times faster when compared to using conventional air drying and/or curing at ambient conditions.

17. The method according to claim 16, wherein the accelerated drying and/or curing of the coating system is between 20 and 100 times faster when compared to using conventional air drying and/or curing at ambient conditions.

18. The method according to claim 1, wherein the irradiation of the coating system after application on at least a part of the structure with infrared radiation emitted by the at least one gas catalytic infrared emitting units on-site, improves adhesion of the coating system to the at least part of a structure by at least 10% when compared to using conventional air drying and/or curing at ambient conditions.

19. The method according to claim 1, wherein the irradiation of the coating system after application on at least a part of the structure with infrared radiation emitted by the at least one gas catalytic infrared emitting units on-site, improves adhesion of the coating system to the at least part of a structure by 3 to 10 MPa when compared to using conventional air drying and/or curing at ambient conditions.

20. The method according claim 1, wherein the structure is made from a material selected from the group consisting of metal, composite, concrete, plastic or wood.

21. The method according to claim 20, wherein the structure is made from steel.

22. A construction having at least one structure treated according to the method of claim 1.

23. A portable drier for accelerating the drying and/or curing of the one or more layers of the coating system according to the method of claim 1, said drier comprising:
at least one gas catalytic infrared emitting unit generating infrared radiation by catalytic combustion of gaseous hydrocarbon fuel and
an enclosure for enclosing the at least part of a structure and the at least one catalytic radiator.

24. The method according to claim 2, wherein the enclosure comprises a scaffold and a tarpaulin.

25. The method according to claim 2, wherein said enclosure is adapted for ventilation by air, whereby a positive pressure inside a housing of the enclosure can be established.

26. The portable drier according to claim 23, wherein 1 to 4 of said catalytic radiators can be fitted into a trunk measuring 60×40×25 cm.

27. The method according to claim 1, whereby the method accelerates the drying and/or curing of the one or more layers of the coating system.

28. The method according to claim 1, wherein the gas catalytic infrared emitting unit is a portable unit.

29. The method according to claim 1, wherein the coating system is a protective coating system.
